(19) United States
(12) Patent Application Publication
(10) Pub. No.: US 2010/0162700 A1
(43) Pub. Date: Jul. 1, 2010

(54) Method and device for intermediate superheating in solar direct evaporation in a solar-thermal power plant

(76) Inventors: Jürgen Birnbaum, Nurnberg (DE); Markus Fichtner, Wolframs-Eschenbach (DE); Georg Haberberger, Bubenreuth (DE); Gerhard Zimmermann, Hochstadt-Aisch (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/531,954

(22) PCT Filed: Mar. 18, 2008
(86) PCT No.: PCT/EP2008/053205

§ 371 Date: Mar. 3, 2010

(30) Foreign Application Priority Data
Mar. 20, 2007 (DE) 10 2007 013 852.2

(51) Int. Cl. F03G 6/00

(52) U.S. Cl. 60/641.8

(57) ABSTRACT

A solar-thermal power plant is provided. The solar-thermal power plant includes a working fluid circuit, a solar steam generator based on direct evaporation and a steam turbine for relieving the working fluid on a relief path while the working fluid supplies technical work. The solar-thermal power plant also includes at least one intermediate superheater, which can be heated using the working fluid. The working fluid may be removed from the circuit upstream of the intermediate superheater and superheated using the working fluid thereof, which can be fed downstream of the heating removal using the relief path. A method for operating a solar-thermal power plant is also provided.

### CROSS REFERENCE TO RELATED APPLICATIONS

This application is the US National Stage of International Application No. PCT/EP2008/053205, filed Mar. 18, 2008 and claims the benefit thereof. The International Application claims the benefits of German application No. 10 2007 013 852.2 DE filed Mar. 20, 2007, both of the applications are incorporated by reference herein in their entirety.

### FIELD OF INVENTION

The invention relates to a method for operating a solar-thermal power plant in which a working fluid circulates in a circuit, with a solar steam generator based on direct evaporation and a steam turbine in which the working fluid is expanded while doing technical work on a relief path, with at least one intermediate superheater, which is heated means of working fluid removed from the circuit upstream of the intermediate superheater and which superheats working fluid by means of an intermediate superheater which can be fed downstream of the heating removal by flowing into the relief path.

### BACKGROUND OF INVENTION

Solar-thermal power plants represent an alternative to conventional power generation. A solar-thermal power plant utilizes solar radiation energy to produce electrical energy. It consists of a solar power plant part for absorption of the sun's energy and a second generally conventional power plant part.

The solar-thermal power plant in such cases comprises a solar array, meaning a concentration system with collectors. The concentrating collectors are the main component of the solar-thermal power plant. Known collectors in such cases are the parabolic trough collector, the fresnel collector, the solar tower and the paraboloid mirror. Parabolic trough collectors concentrate the sun's rays onto an absorber tube placed in the focus line. The sun's energy is absorbed there and passed on as heat to a heat carrier medium.

In such cases thermo oil, water, air or fused salt can be employed as the heat carrier medium.

The conventional power plant part generally comprises a steam turbine as well as a generator and a condenser with, by contrast to a conventional power plant, the heat input from the boiler being replaced by the heat input generated by the solar array.

Currently solar-thermal power plants are embodied with indirect evaporation, i.e. with heat exchangers being connected between the solar power plant part and the conventional power plant part, in order to transfer the energy generated in the solar array circuit from the heat carrier of a solar array circuit to a water-steam circuit of the conventional power plant part.

Direct evaporation represents an option for the future, in which the solar array circuit of the solar power plant part and the water-steam circuit of the conventional power station part form a common circuit, with the feed water being preheated in the solar array, evaporated and superheated and fed in this form to the conventional part. The solar power plant type is thus a solar steam generator.

The conventional power plant part cannot be operated to the optimum with the steam parameters obtained in a solar array with direct evaporation. The condensation of the steam via as large a pressure drop as possible is very restricted by the moisture arising during condensation in the turbine. To minimize the creation of moisture in the turbine when utilizing the greatest possible pressure drop, an intermediate superheating of the steam is necessary.

In a conventional steam power plant the intermediate superheating is undertaken by means of a heat exchanger in the boiler. With solar-thermal power plants with direct evaporation the intermediate superheating can be carried out in a separate solar array. However this version of intermediate superheating does not appear worthwhile since with an intermediate superheating in the solar array a very high pressure loss is to be expected.

### SUMMARY OF INVENTION

The object of the invention which relates to the device is thus to specify a solar-thermal power plant with improved intermediate superheating. A further object is to specify a method for operating such a power plant installation.

This object is achieved in accordance with the invention by the features of the claims.

Further advantageous embodiments are claimed in the subclaims,

The inventive solar-thermal power plant installation comprises a working fluid circuit, a solar steam generator based on direct evaporation and a steam turbine, for condensing the working fluid on a relieving path, with at least one intermediate superheater, which is able to be heated up by working fluid able to be removed upstream of the intermediate superheater and is able to be superheated by the working fluid thereof, which can be fed downstream of the heating removal by following into the relief path. This enables the working fluid to be superheated without the very high loss of pressure to be expected on intermediate superheating in the solar array.

The intermediate superheater is heated by the steam removal before the relief path or by means of tapping off from the relief path of the turbine. Tapping off in context of this document means the removal of steam between two vane stages.

Preferably the intermediate superheater is a steam-steam-heat exchanger which is connected on the primary side into a fresh steam line. In this case fresh steam is removed ahead of the turbine and used for superheating of the cooled intermediate superheating steam.

It is further preferred for the steam-steam heat exchanger to be connected into a tapping-off point of the high-pressure part of the turbine. In this instance a removal of the higher-quality fresh steam is advantageously dispensed with.

In a preferred embodiment the intermediate superheating is undertaken via two steam-steam heat exchangers, of which one is connected on the primary side into a fresh steam line and another on the primary side into a tapping-off point of the high-pressure part. The respective proportion of intermediate superheating can be set as required.

It is advantageous to use the cooled steam of the primary side of the superheater for recuperative feed water preheating.

Depending on the steam parameters a steam separator can be useful in the circuit ahead of the intermediate superheater, in order to move with the largest possible steam content into the steam-steam heat exchanger on the cold secondary side of the intermediate superheater.

In such cases it is further useful for the condensate to be introduced at a suitable point from the steam separator back into the working fluid circuit.

In an advantageous embodiment the solar-thermal power plant system includes a generator for electrical energy generation.

A good increase in efficiency with acceptable constructional outlay is produced if at least two turbines are provided in the relief path, for example a combined high and medium-pressure turbine at the start and a low-pressure turbine at the end of the relief path, with working fluid being subjected to intermediate superheating after the first turbine section in a steam-steam heat exchanger and subsequently being directed to the low-pressure turbine section.

For larger power plant outputs in particular at least three turbines, a high-pressure turbine, a medium-pressure turbine and at least one low-pressure turbine are advantageous in the relief path. One of the options offered by this configuration is an especially flexible design of the intermediate superheating. The working fluid can be removed after the high-pressure turbine and/or after the medium-pressure turbine and subjected to an intermediate superheating in a steam-steam heat exchanger, before it flows into the subsequent downstream turbine. The low-pressure part turbines can always be embodied as single or multi flow. It is also possible to provide a number of low-pressure turbine sections connected to the regenerative intermediate superheating according to the invention.

Especially advantageously the thermo-solar power plant installation comprises parabolic trough collectors, which are technologically highly mature and have the highest concentration factor for linear-concentrating systems, which makes higher process temperatures possible.

In an alternate embodiment fresnel collectors are used. An advantage of fresnel collectors over parabolic trough collectors lies in the tubing and the resulting, comparatively low pressure losses. A further advantage of fresnel collectors are the largely standardized components compared to parabolic trough collectors, which can be manufactures without technological know-how. Fresnel collectors can therefore be procured and maintained at low cost.

A further advantageous alternate embodiment uses a solar tower for direct solar evaporation, which allows the highest process temperatures.

Because of its very high specific thermal capacity or its high specific evaporation enthalpy and its ease of handling, water is a very good heat carrier and thus very suitable as a working fluid.

In relation to the method the object is achieved by a method for operating a solar-thermal power plant system, in which a working fluid circulates in a circuit, with a solar steam generator based on direct evaporation and a steam turbine, in which the working fluid is condensed on a relief path while supplying technical work, with at least one intermediate superheater, which is heated by means of working fluid removed from the circuit upstream of the intermediate superheater and is superheated by means of the working fluid thereof, which is fed downstream of the heating removal by flowing into the relief path.

The method makes use of the facility described The advantages of the device are thus also produced for the method.

### BRIEF DESCRIPTION OF THE DRAWINGS

Further advantages, features and details of the invention emerge from the description given below of preferred exemplary embodiments and drawings as well as from further subclaims.

The invention is explained in further detail on the basis of the drawings.

These show simplified and not-to-scale drawings in the following figures:

FIG. 1 intermediate superheating by means of a fresh steam tapping-off point ahead of the high-pressure turbine and a steam-steam heat exchanger,

FIG. 2 intermediate superheating by means of two steam-steam heat exchangers and two different removed steam flows,

FIG. 3 intermediate superheating by means of a steam-steam heat exchanger (removed steam flow from the first high-pressure turbine tapping-off point),

FIG. 4 intermediate superheating by means of a steam-steam heat exchanger and a specific tapping-off point at the turbine and

FIG. 5 a combination of steam-steam heat exchanger and direct H2 combustion.

The same parts are provided with the same reference symbols in all figures.

### DETAILED DESCRIPTION OF INVENTION

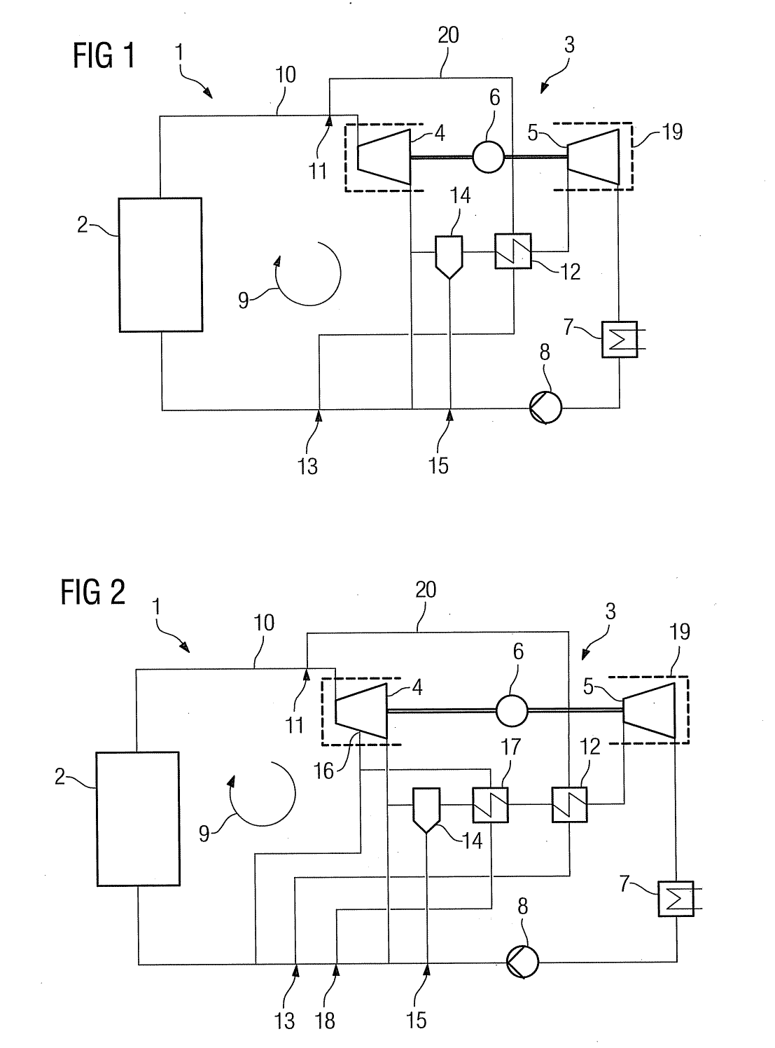

FIG. 1 shows the schematic structure and the circulation process of a solar-thermal power plant system 1 with direct evaporation according to the invention. The system 1 comprises a solar array, in which the solar radiation is concentrated and converted into thermal energy and can typically feature parabolic trough collectors, solar towers, paraboloid mirror or fresnel collectors. Concentrated solar radiation is output to a heat carrier medium which is evaporated and is introduced as working fluid via a fresh steam line 10 into a relief path 19, consisting of a steam turbine 3. The steam turbine 3 comprises a high-pressure turbine 4 and a low-pressure turbine 5, which drive a generator 6. The working fluid is condensed in the turbine and subsequently evaporated in a condenser 7. A feed water pump 8 pumps the evaporated heat carrier medium back again into the solar array 2, with the circuit 9 of the heat carrier medium or the working fluid respectively being closed.

In the exemplary embodiment of FIG. 1 fresh steam from the fresh steam line 10 ahead of the turbine 3 at the removal point 11 and fed to a steam-steam superheater 12 via a line 20 branching off from the fresh steam line 10 for superheating the cold intermediate superheater steam.

The fresh steam is cooled off in this case far enough to enable it to be used for recuperative feed water preheating at the corresponding point in the feed water system (injection point 13). Before the intermediate superheating, should this be necessary because of the steam parameters, a steam separator 14 can also be built into the circuit 9, in order to move with as high a steam content as possible into the steam-steam heat exchanger 12 on the cold intermediate superheater side. The condensate from the steam separator 14 is introduced at a suitable point (injection point 15) back into the feed water circuit 9. The temperature of the hot intermediate superheating steam is produced by the temperature difference of the steam-steam heat exchanger 12 and the saturated steam temperature of the removed steam at the removal point 11 at the pressure predetermined by the solar array 2 and the pressure loss of the steam-steam heat exchanger 12.

FIG. 2 shows a second embodiment of the intermediate superheating at which the steam is fed after its exit from the high-pressure turbine to an intermediate superheating by means of two removal steam flows into two steam-steam heat exchangers. The first removal steam flow is removed from a tapping-off point 16 of the high-pressure turbine 4 and fed to the steam-steam heat exchanger 17. The second removal steam flow is removed from the fresh steam line 10 ahead of the turbine 3 (removal point 11) and used for a second intermediate superheating in a second steam-steam heat exchanger 12. The temperature of the steam from the intermediate superheating in this case is set for both steam-steam heat exchangers 12, 17 via their temperature difference and the saturated steam temperature of the removed steam as a function of its pressure. The removed steam of the working fluid cooled down from the intermediate superheating in the heat exchangers, which occurs either as steam or as condensate, is used at the corresponding points before entry into the solar array for recuperative feed water preheating (injection points 13, 18). Ahead of the two steam-steam heat exchangers 12, 17 a steam separator 14 can optionally be built into the intermediate superheating (depending on the steam parameters of the cold intermediate superheating) in order to move with a highest possible steam content into the heat exchangers 12, 17.

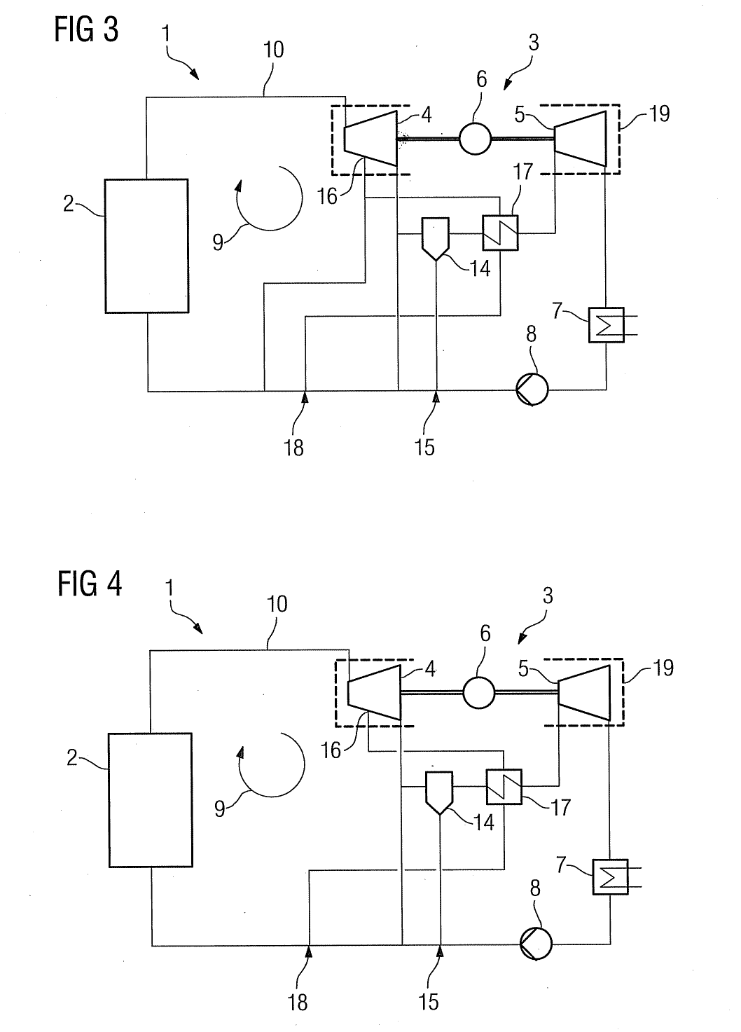

FIG. 3 shows the intermediate superheating by means of a tapping-off point 16 of the high-pressure turbine 4. The removed steam is used for intermediate superheating of the cold steam after the high-pressure turbine 4 in a steam-steam heat exchanger 17. The cooled removed steam is introduced for recuperative feed water preheating into the feed water system (injection point 18). Before the heat exchanger 17, depending on the cold intermediate superheating parameters, a steam separator 14 can be built in order to obtain as high a steam content as possible in the heat exchanger 17. The separated condensate is introduced at an appropriate point (injection point 15) into the feed water circuit.

In an embodiment shown in FIG. 4 a tapping-off point 16 is provided in the high-pressure turbine specifically for the superheating of the cold intermediate superheating steam and is designed for the requirements of the intermediate superheating. In a steam-steam heat exchanger 17 the cold intermediate superheating steam will be superheated by means of the steam at the tapping-off point 16 on the turbine 3. The cooled-down steam is introduced at the appropriate point (injection point 18) in the feed water circuit for recuperative feed water preheating. A steam separator 14 can optionally also be built in ahead of the steam-steam heat exchanger 17 which ensures an optimum steam content in the steam-steam heat exchanger 17. The condensate is introduced for recuperative feed water preheating at the corresponding point (injection point 15) in the feed water circuit. Whether the use of a steam separator 14 makes sense depends on the steam parameters of the cold intermediate superheating.

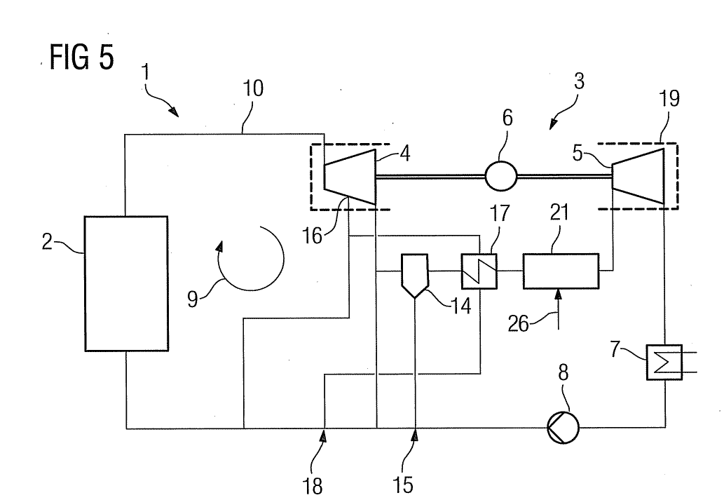

FIG. 5 shows an embodiment in which the first intermediate superheating of the partly condensed steam is realized using a steam-steam heat exchanger 17 and the intermediate superheating is undertaken on the necessary steam parameters by means of supplementary firing 21, for example an H2 burner, which fires directly into the intermediate superheating. The steam for the first intermediate superheating can in this case be removed either from a specific tapping-off point 16 of the high-pressure turbine or from a removal point from a tapping-off point for feed water preheating. The hydrogen 26 for this type of firing can be obtained by electrolysis or thermal splitting.

All the above-mentioned arrangements of the intermediate superheating by means of heat exchangers are likewise conceivable in any combination with the supplementary firing explained here (fossil, biomass, H2).

1.-18. (canceled)

19. A solar-thermal power plant with a working fluid circuit, comprising:
a solar steam generator based on direct evaporation;
a steam turbine used for condensation of a working fluid which supplies technical work on a relief path; and
an intermediate superheater, which is heated up by the working fluid removed from the working fluid circuit upstream of the intermediate superheater,
wherein colder working fluid is superheated in the intermediate superheater, and
wherein the working fluid may be fed downstream of the heating removal using the relief path.

20. The solar-thermal power plant as claimed in claim 19, wherein the intermediate superheater is a steam-steam heat exchanger.

21. The solar-thermal power plant as claimed in claim 20,
wherein the solar steam generator is connected to the steam turbine via a fresh steam line, and
wherein the steam-steam heat exchanger is connected on a primary side to a line branching off from the fresh steam line.

22. The solar-thermal power plant as claimed in claim 20, wherein the steam-steam heat exchanger is connected on the primary side to a tapping-off point of the steam turbine.

23. The solar-thermal power plant as claimed in claim 22, wherein the steam-steam heat exchanger is connected on the primary side to the tapping-off point of a high-pressure turbine of the steam turbine.

24. The solar-thermal power plant as claimed in claim 19,
wherein a first steam-steam heat exchanger is connected on the primary side to a line branching off from the fresh steam line, and
wherein a second steam-steam heat exchanger is connected on the primary side to the tapping-off point of the high-pressure turbine.

25. The solar-thermal power plant as claimed in claim 19, wherein the primary side of the steam-steam heat exchanger is connected to a plurality of injection points in the working fluid circuit for recuperative feed water preheating.

26. The solar-thermal power plant as claimed in claim 19, wherein a steam separator is connected ahead of the intermediate superheater.

27. The solar-thermal power plant as claimed in claim 26, wherein a condensate output of the steam separator is connected to the working fluid circuit.

28. The solar-thermal power plant as claimed in claim 19, wherein the solar-thermal power plaint further comprises a generator for electrical energy generation.

29. The solar-thermal power plant as claimed in claim 19, wherein at least two turbines are provided in the relief path, a combined high-pressure/medium pressure turbine at a start of the relief path and a low-pressure turbine at an end of the relief path.

30. The solar-thermal power plant as claimed in claim 19, wherein at least three turbines are provided in the relief path, a high-pressure turbine at the start of the relief path a medium-pressure and the low-pressure turbine at the end of the relief path.

31. The solar-thermal power plant as claimed in claim 19,
wherein the intermediate superheater is connected ahead of the low-pressure turbine in order to heat up an overall flow of the working fluid.

32. The solar-thermal power plant as claimed in claim 19, wherein a solar array comprises a plurality of parabolic trough collectors.

33. The solar-thermal power plant as claimed in claim 19, wherein the solar array comprises a plurality of fresnel collectors.

34. The solar-thermal power plant as claimed in claim 19, wherein the solar array comprises a solar tower.

35. The solar-thermal power plant as claimed in claim 19, wherein the working fluid is water or water vapor.

36. A method for operating a solar-thermal power plant, comprising:
directing a working fluid to a circuit;
directly evaporating the working fluid in the circuit by solar radiation while the working fluid supplies technical work on a relief path; and
superheating cooler working fluid in an intermediate superheater which is heated using hotter working fluid removed from the circuit upstream from the intermediate superheater.

37. The method for operating a solar-thermal power plant as claimed in claim 36, wherein the intermediate superheater is a steam-steam heat exchanger.

38. The method for operating a solar-thermal power plant as claimed in claim 36, wherein the working fluid is water or water vapor.
